(19) United States
(12) Patent Application Publication
(10) Pub. No.: US 2003/0182130 A1
(43) Pub. Date: Sep. 25, 2003

(54) Apparatus and method for recording meeting

(75) Inventors: Bruce W.H. Sun, Taipei (TW); Chih Long Lin, Kaohsiung Hsien (TW)

Correspondence Address: BRUCE H. TROXELL, SUITE 1404, 5205 LEESBURG PIKE, FALLS CHURCH, VA, 22041, US

(73) Assignee: Multisuns Corp.

(21) Appl. No.: 10/102,823

(22) Filed: Mar. 22, 2002

(51) Int. Cl. G10L 21/00

(52) U.S. Cl. 704/275

(57) ABSTRACT

An apparatus for recording a meeting held in a room comprises a signal receiving unit, a CODEC unit, a data processing unit, an input control unit, a storage unit, and a power source. A process for recording the meeting comprises the steps of basic input control, state control, digital data processing, voice searching, voice processing, and file system management. With this, voice of an individual who is making a speech during the meeting is located, amplified, and compressed prior to being recorded in a file of minutes. The minutes is stored in the storage unit in digital format so as to improve recording quality and facilitate reading and inquiry of the minutes.

### BACKGROUND OF THE INVENTION

1. Field of the Invention

The present invention relates to meeting recording devices and more particularly to an improved apparatus and method for recording a meeting held in a room.

2. Description of Related Art

Conventionally, a recorder is used to record what was said in a meeting. However, the recording quality is poor because echo was produced in the meeting room. Recently, an improved digital recorder is available. However, the echo problem still exists. In the employment of either conventional recorder or digital recorder, microphone associated with the recorder is placed as near an individual who is making a speech as possible for hopefully obtaining a better recording quality. Hence, there are two implementations. One is providing a microphone to each meeting participant. The other is continuously shifting the only recorder to the one who is making a speech during the meeting. Both of above are disadvantageous for the following reasons: As respect to the first case, wiring of such many microphones tends to become messy. Further, installation cost is relatively higher. Furthermore, it is not aesthetic. Thus improvement exists.

### SUMMARY OF THE INVENTION

It is an object of the present invention to provide an apparatus and method for recording a meeting held in a room having advantages of large memory for recording a large minutes in a digital format, high-quality, and direction adjustment, reading, and inquiry during the recording. By utilizing this, the management and inquiry of minutes are made easier.

In one aspect of the present invention, there is provided a signal receiving unit comprising a plurality of microphones and a signal amplifier for amplifying signals transmitted from the microphones. The amplified signal is in turn used as a guide for searching a current voice source (i.e., an individual who is making a speech during a meeting) of the meeting. Signal of the located voice source is amplified a predetermined number of times so as to improve a recording quality thereof.

In another aspect of the present invention, there is provided a storage unit for storing compressed voice data so that it is possible of recording a large minutes in a digital format for a long period of time.

In still another aspect of the present invention, there is provided an input control unit for user control signal input. Hence, direction adjustment, reading, and inquiry with respect to the recording are made convenient during the recording.

In yet another aspect of the present invention, there are provided a speaker unit, a digital-to-analog converter, and corresponding processing steps for user to listen voice data of the meeting at any time.

In a further aspect of the present invention, there is provided a display unit for displaying operations in real time.

In still further aspect of the present invention, there is provided a wireless input control unit for user input instructions by wireless.

To achieve the above and other objects, the present invention provides an apparatus for recording a meeting held in a room comprising a signal receiving unit including a plurality of microphones and a signal amplifier; a coder/decoder (CODEC) unit implemented as an analog-to-digital converter; a data processing unit including a logic control device and a central processing device; an input control unit for inputting control signal from user to the central processing device; a nonvolatile storage unit controlled by the central processing device in data Input/output (I/O); and a power source for supplying a rated voltage. The present invention further provides a method for recording the meeting comprising the steps of: (a) basic input control for receiving a control signal from the input control unit, queuing events, and converting the control signal into corresponding index of the event; (b) state control for converting a current state of the event into the other one based on the current state; (c) digital data processing for controlling data I/O and timing of the signal receiving unit; (d) voice searching for receiving data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal via step (c); (e) voice processing for receiving the amplified signal and compressing the same; and (f) file system management for receiving the compressed signal and controlling an access to the compressed signal by the storage unit. With this, voice of an individual who is making a speech during the meeting can be easily located and amplified. Also, minutes recorded in files are compressed prior to storing in the storage unit. It not only improves recording quality but also facilitates reading and inquiry of the minutes by manipulating the input control unit since minutes are recorded in digital format in a large memory of the storage unit.

The above and other objects, features and advantages of the present invention will become apparent from the following detailed description taken with the accompanying drawings.

### BRIEF DESCRIPTION OF THE DRAWINGS

FIG. 1 is a block diagram of a first preferred embodiment of apparatus for recording meeting according to the invention;

FIG. 2 is a flow chart illustrating a process for recording meeting according to the first preferred embodiment of the invention;

FIG. 3 is a block diagram of a second preferred embodiment of apparatus for recording meeting according to the invention;

FIG. 4 is a block diagram of a third preferred embodiment of apparatus for recording meeting according to the invention;

FIG. 5 is a flow chart illustrating a process for recording meeting according to the third preferred embodiment of the invention;

FIG. 6 is a block diagram of a fourth preferred embodiment of apparatus for recording meeting according to the invention;

FIG. 7 is a flow chart illustrating a process for recording meeting according to the fourth preferred embodiment of the invention; and

FIG. 8 is a block diagram of a fifth preferred embodiment of apparatus for recording meeting according to the invention.

### DETAILED DESCRIPTION OF THE PREFERRED EMBODIMENTS

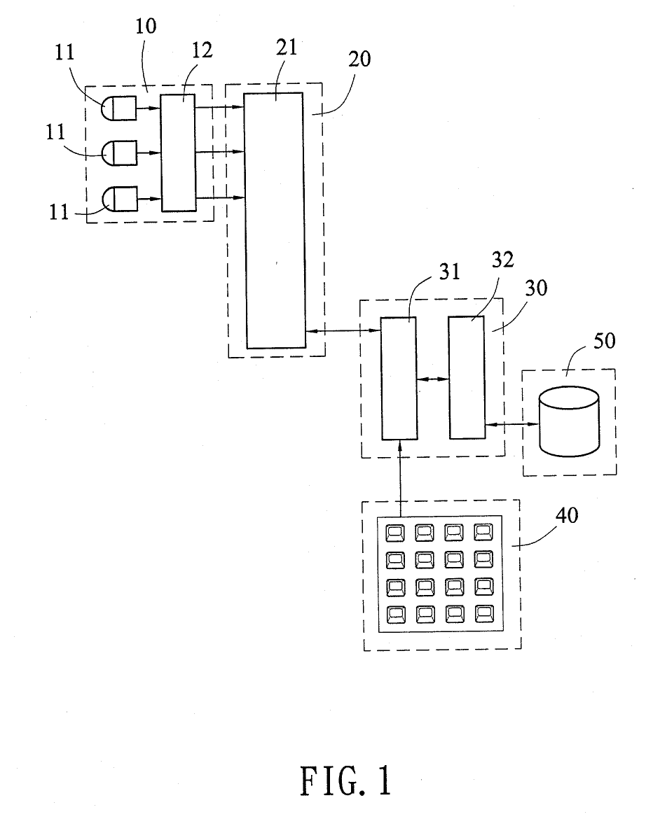

Referring to FIG. 1, there is shown a first preferred embodiment of apparatus for recording meeting in accordance with the invention. Note that the meeting described herein means a meeting held in a room not a teleconference such as one conducted over telephone or the Internet and videoconferencing. As shown, the apparatus comprises a signal receiving unit 10 including a plurality of coplanar microphones (three are shown) 11 for forming a wide signal receiving area and a signal amplifier 12 for amplifying signals transmitted from the microphones 11 wherein each of the microphones 11 is implemented as a capacitive or an inductive microphone; a coder/decoder (CODEC) unit 20 including an analog-to-digital converter (ADC) 21 for converting analog signal received from microphones 11 into digital one; a data processing unit 30 including a logic control device 31 and a central processing device 32 wherein logic control device 31 is implemented as a field programmable gate array (FPGA) chip or other chip having the same capability for combining digital signals from peripheral devices into one for ease of control, and the central processing device 32 is responsible for data input/output (I/O) wherein the central processing device is implemented as one of digital signal processing (DSP) chip, Intel central processing unit (CPU) (e.g., 80x86 or Pentium series), micro-controller (8051, 8096, or Micron), and other chip for processing data I/O; an input control unit 40 implemented as a keypad for inputting control signal from user to the central processing device 32 so as to perform a direction adjustment, a recording, a reading, or an inquiry; a storage unit 50 implemented as a nonvolatile memory (e.g., floppy disk, CD-RW, DVD-RAM, erasable programmable ROM (EEPROM), Flash ROM, Compact Flash, Smart Media, MultiMedia Card (MMC), Secure Digital (SD), Memory Stick, Memory Disk (MD), or other storage means) being controlled by the central processing device 32 in data I/O; and a power source (not shown) for supplying a rated voltage to above components.

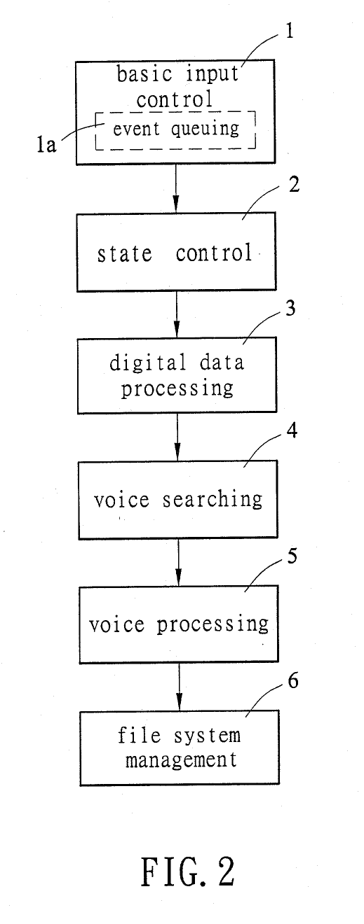

Referring to FIG. 2, there is shown a flow chart illustrating a process for recording meeting according to the first preferred embodiment of the invention. The process comprises the following steps:

Step 1 of basic input control: It is responsible for receiving a control signal from the input control unit 40, queuing events in sub-step 1a, and converting the control signal into corresponding index of the event.

Step 2 of state control: It is responsible for converting a current state of the event into the other one based on the current state.

Step 3 of digital data processing: It is responsible for controlling data I/O and timing of the signal receiving unit 10.

Step 4 of voice searching: It is responsible for receiving digital data from the signal receiving unit 10 and the CODEC unit 20, guiding the received data for searching a voice source of the signal receiving unit 10, synthesizing signals toward the voice source, amplifying the synthesized signal a predetermined number of times (three times in this preferred embodiment) and decreasing the other non-synthesized signals a predetermined number of times (three times in this preferred embodiment), and outputting the amplified signal via step 3.

Step 5 of voice processing: It is responsible for receiving the amplified digital signal and compressing the same. Note that a voice compression format can be selected from MP3, GSM 6.10, CELP 3.2a, MELP, ACELP, TRUE SPEECH, LPC 10e, ADPCM, ALAW, ULAW, or other applicable.

Step 6 of file system management: It is responsible for receiving the compressed signal and controlling an access to the compressed signal by the storage unit 50 wherein the file system is selected from FAT 12, FAT 16, Virtual FAT (VFAT), FAT 32, NT File System (NTFS), Ext 2 (Linux), or other applicable.

With this, voice of an individual who is making a speech during a meeting can be easily located and amplified. Also, minutes recorded in files are compressed prior to storing in the storage unit. It not only improves recording quality but also facilitates reading and inquiry of the minutes by manipulating the input control unit since minutes are recorded in digital format in a large memory of the storage unit.

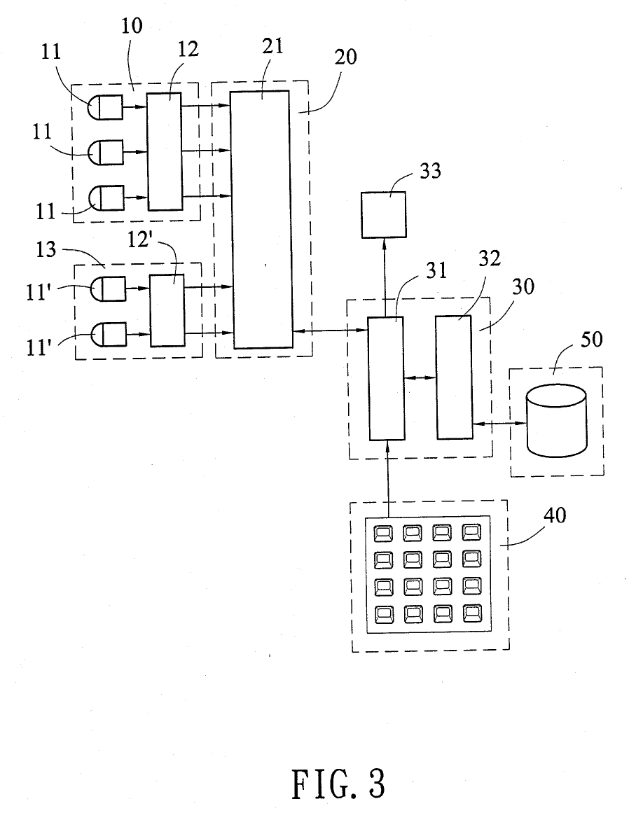

Referring to FIG. 3, there is shown a second preferred embodiment of the apparatus according to the invention. The differences between first and second preferred embodiments are detailed below. In the second preferred embodiment, there are further provided a second signal receiving unit 13 including at least one microphone 11′ (two are shown) and an associated signal amplifier 12′ for amplifying signals transmitted from microphones 11′, and a timer 33 for providing real time information which in conjunction with naming rule specified by data processing unit 30 are employed by file system management in step 6 for processing filenames wherein second signal receiving unit 13 is not coplanar with respect to signal receiving unit 10 for further expanding the signal receiving area into a three dimensional (3D) space.

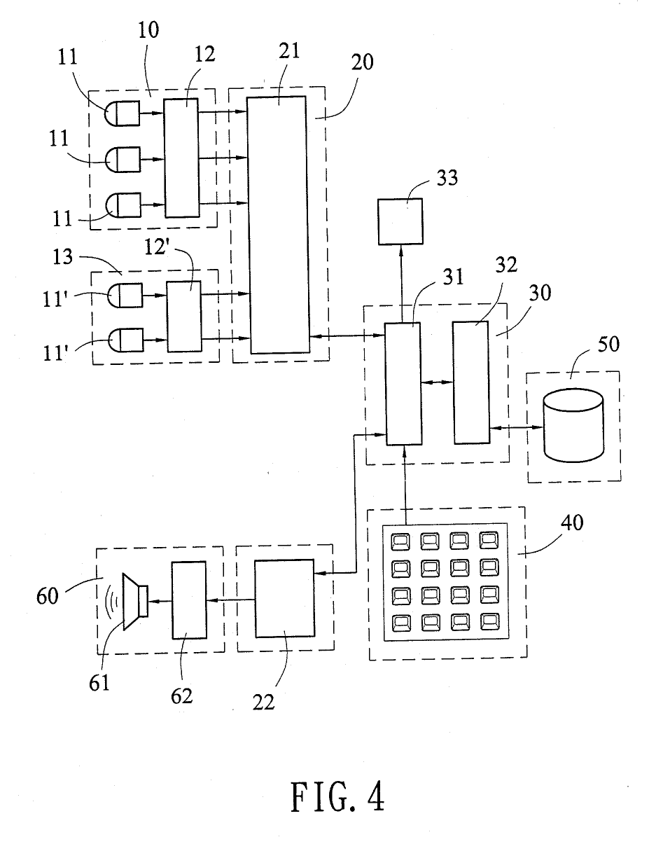

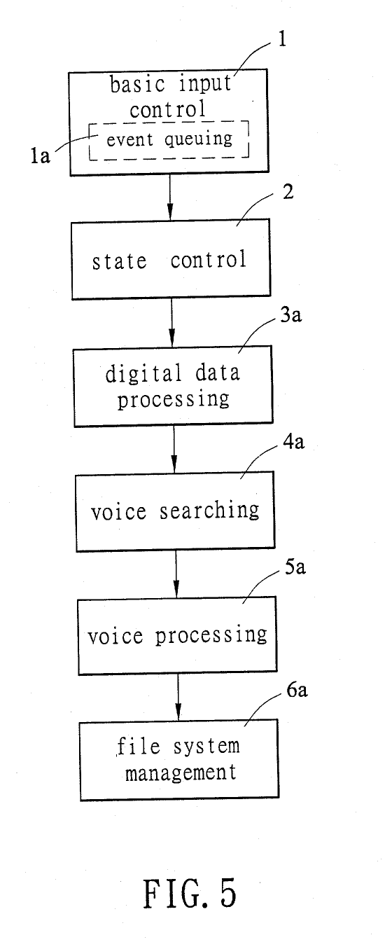

Referring to FIG. 4, there is shown a third preferred embodiment of the apparatus according to the invention. The differences between second and third preferred embodiments are detailed below. In the third preferred embodiment, there are further provided a digital-to-analog converter (DAC) 22 formed of a chip in CODEC unit 20 for converting digital signal sent from central processing device 32 into analog one; and a speaker unit 60 including a power amplifier 62 for amplifying signal outputted from DAC 22 and a speaker 61 for outputting the amplified sound volume for user listening. Referring to FIG. 5, there is shown a flow chart illustrating a process for recording meeting according to the third preferred embodiment of the invention. Steps 1, 1a, and 2 are the same in both first and third preferred embodiments. Thus a detailed description thereof is omitted herein for the sake of brevity. The differences between processes of first and third preferred embodiments are detailed below. In the process of third preferred embodiment, step 3a of digital data processing is responsible for controlling data I/O and timing of the signal receiving unit 10 and DAC 22 so that voice quality can be further improved; step 4a of voice searching is responsible for receiving digital data from the signal receiving unit 10 and the CODEC unit 20, guiding the received data for searching a voice source of the signal receiving unit 10, synthesizing signals toward the voice source, amplifying the synthesized signal a predetermined number of times (three times in this preferred embodiment) and decreasing the other non-synthesized signals a predetermined number of times (three times in this preferred embodiment), and outputting the amplified signal to speaker unit 60 and DAC 22 via step 3a; step 5a of voice processing is responsible for receiving the amplified digital signal from step 3a and compressing the same, decompressing data sent from step 6a as commanded, and sending the decompressed data back to step 3a; and step 6a of file system management is responsible for receiving the compressed signal and controlling an access to the compressed signal by the storage unit 50, and reading data from the storage unit 50 prior to sending the same to step 5a.

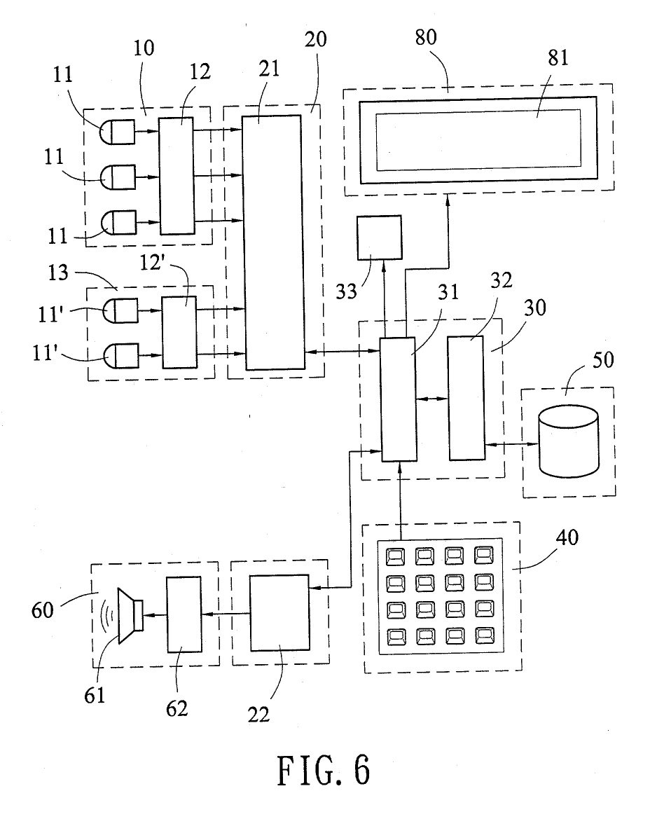

Referring to FIG. 6, there is shown a fourth preferred embodiment of the apparatus according to the invention. The difference between third and fourth preferred embodiments is detailed below. In the fourth preferred embodiment, there is further provided a display unit 80 including a display 81 controlled by logic control device 31 for receiving a control signal from central processing device 32. Display 81 may be Cathode ray tube (CRT) monitor, liquid crystal display (LCD) monitor (e.g., TSDN, or thin film transistor (TFT)-LCD), or the like.

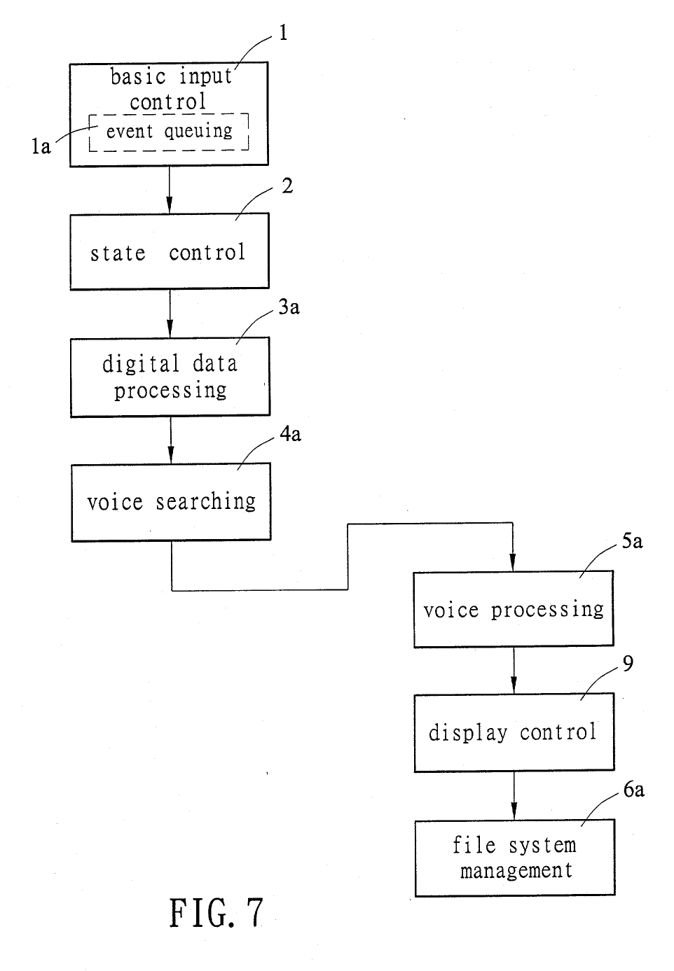

Referring to FIG. 7, there is shown a flow chart illustrating a process for recording meeting according to the fourth preferred embodiment of the invention. Steps 1, 1a, 2, 3a, 4a, 5a, and 6a are the same in both third and fourth preferred embodiments. Thus a detailed description thereof is omitted herein for the sake of brevity. The difference between processes of third and fourth preferred embodiments is detailed below. In the process of fourth preferred embodiment, there is further provided a step 9 of display control responsible for controlling a display of display unit 80 as instructed by step 2.

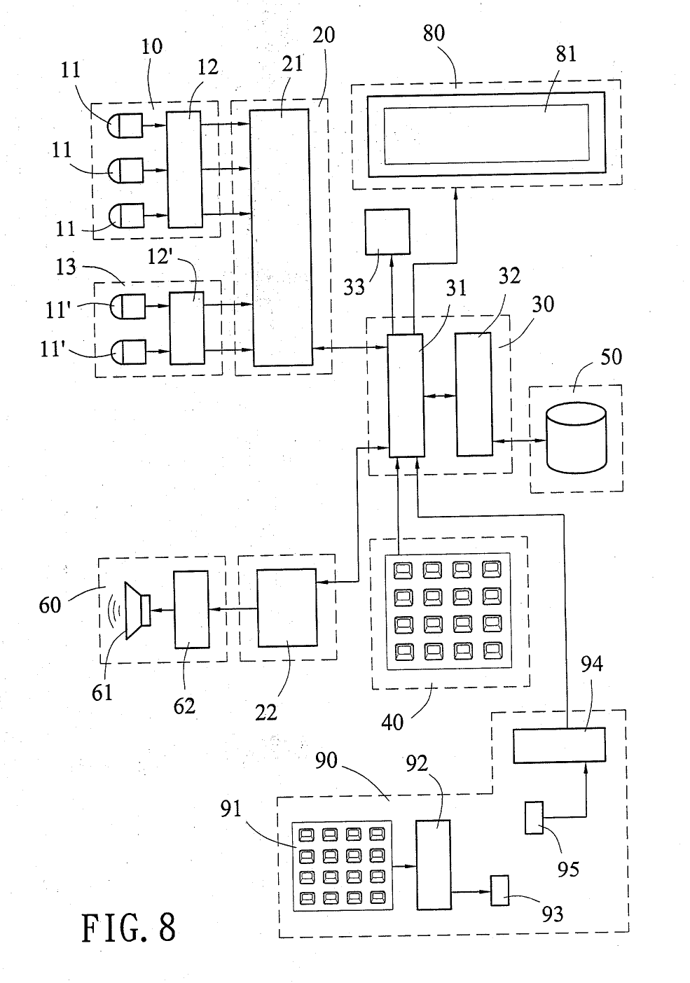

Referring to FIG. 8, there is shown a fifth preferred embodiment of the apparatus according to the invention. The difference between fourth and fifth preferred embodiments is detailed below. In the fifth preferred embodiment, there is further provided a wireless input control unit 90 for user input instructions by wireless. Wireless input control unit 90 comprises a keypad 91 for user input commands, a wireless encoder 92, a transmitter 93 both for converting commands into signal for transmission, a wireless decoder 94, and a receiver 95 both for receiving control signals which are in turn combined by logic control device 31 prior to sending to central processing device 32. This can effect a wireless control.

Other variations of the apparatus for recording meeting are contemplated in this invention. For example, CODEC unit 20 may be implemented as an I/O chip capable of performing the functions of ADC 21 and DAC 22. Further, logic control device 31 and central processing device 32 of data processing unit 30 may be combined on a single chip. Furthermore, signal receiving unit 10, CODEC unit 20, data processing unit 30, input control unit 40, and storage unit 50 may be combined on a single chip by means of any other semiconductor manufacturing technique.

While the invention herein disclosed has been described by means of specific embodiments, numerous modifications and variations could be made thereto by those skilled in the art without departing from the scope and spirit of the invention set forth in the claims.

What is claimed is:

1. An apparatus for recording a meeting held in a room, comprising:
a first signal receiving unit including a plurality of microphones and a first signal amplifier;
a coder/decoder (CODEC) unit implemented as an analog-to-digital converter (ADC);
a data processing unit including a logic control device and a central processing device;
an input control unit for inputting control signal from user to the central processing device;
a nonvolatile storage unit controlled by the central processing device in data input/output (I/O); and
a power source for supplying a rated voltage;
whereby voice of an individual who is making a speech during the meeting is located, amplified, and compressed prior to being recorded in a file of minutes, and the minutes is stored in the storage unit in digital format so as to improve a recording quality and facilitate a reading and an inquiry of the minutes.

2. The apparatus of claim 1, wherein the first signal receiving unit includes three coplanar microphones, each being implemented as either a capacitive or an inductive microphone.

3. The apparatus of claim 1, wherein the logic control device is implemented as a field programmable gate array (FPGA) chip or other chip having the same capability, and the central processing device is responsible for data I/O, the central processing device being implemented as one of digital signal processing (DSP) chip, Intel central processing unit (CPU) such as 80x86 or Pentium series, micro-controller such as 8051, 8096, or Micron, and other chip for processing data I/O.

4. The apparatus of claim 1, wherein the logic control device and the central processing device are combined on a single chip.

5. The apparatus of claim 1, wherein the storage unit is a nonvolatile memory implemented as floppy disk, read-only memory (ROM), CD-RW, erasable programmable ROM (EEPROM), Flash ROM, Compact Flash, Smart Media, MultiMedia Card (MMC), Secure Digital (SD), Memory Stick, Memory Disk (MD), or other storage means in data I/O.

6. The apparatus of claim 1, further comprising a second signal receiving unit including at least one microphone and a second signal amplifier wherein the second signal receiving unit is not coplanar with respect to the first signal receiving unit.

7. The apparatus of claim 6, wherein at least one microphone of the second signal receiving unit and the second signal amplifier are combined in the second signal receiving unit.

8. The apparatus of claim 1, further comprising a timer for providing real time information which in conjunction with a naming rule specified by the data processing unit are employed for processing filenames.

9. The apparatus of claim 1, wherein the signal receiving unit, the CODEC unit, the data processing unit, the input control unit, and the storage unit are combined on a single chip by means of one of a plurality of semiconductor manufacturing techniques.

10. The apparatus of claim 1, further comprising a digital-to-analog converter (DAC) formed of a chip in the CODEC unit for converting a digital signal sent from the central processing device into an analog signal; and a speaker unit including a power amplifier for amplifying the analog signal outputted from the DAC and a speaker for output.

11. The apparatus of claim 10, wherein the ADC and the DAC are combined on a chip included in the CODEC unit.

12. The apparatus of claim 1, further comprising a display unit including a display controlled by the logic control device for receiving a control signal from the central processing device wherein the display is one of cathode ray tube (CRT) monitor and liquid crystal display (LCD) monitor such as TSDN or thin film transistor (TFT)-LCD.

13. The apparatus of claim 1, further comprising a wireless input control unit including a keypad for user input commands, a wireless encoder, a transmitter both for converting commands into a signal for transmission, a wireless decoder, and a receiver both for receiving the signals which are in turn combined by the logic control device prior to sending to the central processing device.

14. The apparatus of claim 1, further comprising a first software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the signal receiving unit;
(d) voice searching for receiving data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal via the step (c);
(e) voice processing for receiving the amplified signal and compressing the same; and
(f) file system management for receiving the compressed signal and controlling an access to the compressed signal by the storage unit.

15. The apparatus of claim 14, wherein in the step (d) the synthesized signal is amplified three times, and the other non-synthesized signals are decreased three times.

16. The apparatus of claim 14, wherein in the step (e) a voice compression format is selected from MP3, GSM 6.10, CELP 3.2a, MELP, ACELP, TRUE SPEECH, LPC 10e, ADPCM, ALAW, or ULAW.

17. The apparatus of claim 14, wherein in the step (f) a file system is selected from FAT 12, FAT 16, Virtual FAT (VFAT), FAT 32, NT File System (NTFS), or Ext 2 (Linux).

18. The apparatus of claim 10, further comprising a second software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the signal receiving unit and the DAC so as to further improve the recording quality;
(d) voice searching for receiving digital data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal to the speaker unit and the DAC via the step (c);
(e) voice processing is responsible for receiving the amplified digital signal from the step (c) and compressing the same, decompressing data sent from step (f) as commanded, and sending the decompressed data back to the step (c); and
(f) file system management for receiving the compressed signal and controlling an access to the compressed signal by the storage unit, and reading data from the storage unit prior to sending the same to the step (e).

19. The apparatus of claim 12, further comprising a third software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the signal receiving unit and the DAC so as to further improve the recording quality;
(d) voice searching for receiving digital data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal to the speaker unit and the DAC via the step (c);
(e) voice processing is responsible for receiving the amplified digital signal from the step (c) and compressing the same, decompressing data sent from step (g) as commanded, and sending the decompressed data back to the step (c);
(f) display control for controlling a display of the display unit as instructed by the step (b); and
(g) file system management for receiving the compressed signal and controlling an access to the compressed signal by the storage unit, and reading data from the storage unit prior to sending the same to the step (e).

20. An apparatus for recording a meeting held in a room, comprising:
a first signal receiving unit including a plurality of microphones and a first signal amplifier;
a coder/decoder (CODEC) unit implemented as an analog-to-digital converter (ADC);
a data processing unit including a logic control device and a central processing device;
an input control unit for inputting control signal from user to the central processing device;
a digital-to-analog converter (DAC) for converting digital data outputted from the central processing device into an analog signal;
a speaker unit for amplifying the analog signal received from the DAC and outputting the same;
a display unit controlled by the logic control device for receiving the control signal from the central processing device;
a timer controlled by the logic control device for providing real time information;
a nonvolatile storage unit controlled by the central processing device in data input/output (I/O);
a power source for supplying a rated voltage; and
a software comprising the steps of:
(a) basic input control for receiving a control signal from the input control unit, queuing events, and converting the control signal into corresponding index of the event;
(b) state control for converting a current state of the event into the other one based on the current state;
(c) digital data processing for controlling data I/O and timing of the signal receiving unit and the DAC so as to further improve the recording quality;
(d) voice searching for receiving digital data from the signal receiving unit and the CODEC unit, guiding the received data for searching a voice source of the signal receiving unit, synthesizing signals toward the voice source, amplifying the synthesized signal a predetermined number of times, decreasing the other non-synthesized signals a predetermined number of times, and outputting the amplified signal to the speaker unit and the DAC via the step (c);
(e) voice processing is responsible for receiving the amplified digital signal from the step (c) and compressing the same, decompressing data sent from step (g) as commanded, and sending the decompressed data back to the step (c);
(f) display control for controlling a display of the display unit as instructed by the step (b); and
(g) file system management for receiving the compressed signal and controlling an access to the compressed signal by the storage unit, and reading data from the storage unit prior to sending the same to the step (e).
